(19) United States
(12) Patent Application Publication
(10) Pub. No.: US 2026/0056529 A1
(43) Pub. Date: Feb. 26, 2026

(54) CONFIGURABLE ERGONOMIC CNC CONTROL

(71) Applicant: Hurco Companies Inc., Indianapolis, IN (US)

(72) Inventors: Paul J. Gray, Zionsville, IN (US); David G. Coffman, Frankfort, IN (US); Gregory S. Volovic, Carmel, IN (US)

(21) Appl. No.: 18/813,733

(22) Filed: Aug. 23, 2024

(51) Int. Cl. G05B 19/409

(52) U.S. Cl. CPC G05B 19/409; G05B 2219/33099

(57) ABSTRACT

A CNC control is provided, comprising: a display having a curved screen configured to couple to a CNC machine to permit rotation and tilting of the curved screen relative to the CNC machine; a control panel coupled to the display and including a plurality of input devices in communication with the display, the control panel being movable relative to the display; and a plurality of control boxes removably coupled to the curved screen, each of the plurality of control boxes including at least one input device in communication with the display.

### FIELD OF THE DISCLOSURE

The present disclosure pertains to CNC controls, and more particularly to a CNC control having a curved screen, movable control panel and configurable control boxes.

### BACKGROUND

Traditionally Computer Numerical Control (“CNC”) control designs, such as the CNC control 10 shown in FIG. 1, have consisted of flat panel boxes 12 with numerous buttons 14 and dials 16 to control functions on the CNC machine 18 with a simple digital display 20 to show the machine Digital Read Out (“DRO”), machine axes positions and various other operational states of the machine such as a list of program lines, coolant state, feedrate, rapid feedrate, and spindle override percentages among other things important for operators to see.

The limited functionality of the traditional CNC control systems was sufficient for most traditional CNC machines as the machine control capabilities were minimal and structured around setting up parts, tools and running programs that were generated with offline software and loaded into the CNC control. FIG. 2 shows the typical CNC process 22. The process 22 generally includes loading a CAD solid model into the CNC control (step 24), identifying the CNC machine, its setup and operation sequence (step 26), programming tool paths for forming features on the part (step 28), posting the tool paths to the CNC machine (step 30), loading a numeric control program, setting up the part and tools (step 32), cutting the part with the CNC machine (step 34) and making in-process adjustments (step 36). In such a conventional process 22, the operator interaction with the CNC control only includes steps 32 and 36. Hence, the amount of time operators need to spend working on the actual CNC control with offline programming is limited and the amount of interaction and information needed to be presented to the operator are also consequently limited.

The introduction of PC computer controls in CNC control systems opened new possibilities and functionality making the interface with the CNC control a more interactive experience and important tool for operators. Also, some CNC manufacturers included the ability to create programs to cut parts right on the CNC control as an option to loading offline-generated part programs. Programming parts on the CNC control requires additional geometric data input and graphical display of the part being programmed to provide feedback to the operator that the program is correct. FIG. 3 shows the on-control part programming process 38. The process 38 generally includes loading a solid model of the part (step 40), selecting and identifying features (step 42), creating the part program (step 44), selecting operations, tools and parameters (step 46), running a simulation using the program (step 48), setting up the part and the tools (step 50), cutting the part (step 52) and making in-process adjustments (step 54). In process 38 the operator interacts with the CNC control during steps 40-50 and 54. With this programming paradigm, operators spend significantly more time and perform considerably more interaction with the CNC control.

FIG. 4 shows a 1990's era CNC control 56 manufactured by Hurco Companies, Inc. as an example of an on-control part programming controller. The CNC control 56 includes dual CRT screens 58, 60 and a center stack 62 of configurable function keys 64 that change function based on the current information displayed on the screens 58, 60 (i.e., the keys 64 are context-sensitive). The CNC control 56 also includes various dedicated control clusters 66, buttons 68, knobs 70 and other input devices 72.

Continual advancement of CNC controls over the years has led to the increased prevalence of the presentation of graphical display information making it easier to decipher the current state of the CNC machine and which has now become mainstream in the top tier CNC controls. Furthermore, controls with part programming capabilities have likewise further advanced their programming and machining cycles making the user interface and experience, including ergonomics, critical to operators as operator time working on and interacting with the CNC controls have consequently also increased. The popularization of flat panel touch-screens helped reduced the overall control dimensions and further improved the ergonomics of CNC controls making them easier to use as well.

Today, it is easy to find examples of large flat panel single-screen CNC controls 74, such as those depicted in FIGS. 5A-C, that include a flat panel screen 76 and a control panel 78. These CNC controls 74 show graphical information of the program and cutting process along with advanced DRO information about the machine state.

FIGS. 6A-D depict dual screen CNC controls 80, which are also prevalent in the market today. The CNC controls 80 typically include a control panel 82, a primary screen 84, and a secondary screen 86 often positioned at an angle relative to the primary DRO screen 84 to make viewing both screens from a single position in front of the CNC control 80 easy and ergonomic by minimizing head and eye movement.

However, conventional CNC controls still present ergonomic and other challenges and limitations. Therefore, there is a need to provide a configurable, ergonomic CNC control with improved interface ergonomics and functionality to further enhance the user experience.

### SUMMARY

In one embodiment, the present disclosure provides a CNC control, comprising: a display having a curved screen surrounded by a bezel having a first edge and a second edge, the first edge being longer than the second edge; a mounting bracket coupled to the display to permit rotation of the display between a vertical orientation and a horizontal orientation; a control panel including at least one input device in communication with the display; and a movable coupler connecting the control panel to the display; wherein the control panel is movable relative to the display via the movable coupler to provide clearance for the display to move between the vertical orientation and the horizontal orientation. One aspect of this embodiment further comprises at least one control box configured for removable coupling to the first edge and/or the second edge of the bezel of the screen, the at least one control box including at least one auxiliary input device in communication with the display. In a variant of this aspect, the at least one control box is configured for removable coupling to the control panel. In another variant, the at least one control box includes a wrist rest for supporting a wrist of a user interacting with the at least one auxiliary input device. In yet another variant, the at least one control box includes a first cluster of control boxes removably coupled to one side of the screen and a second cluster of control boxes removably coupled to another side of the screen that is opposite of the one side. In another aspect of this embodiment, the at least one input device includes a keyboard. In another aspect, the movable coupler includes a telescopic joint connecting the control panel to the display, the telescopic joint enabling extension and retraction of the control panel away from and toward the display. In yet another aspect, the movable coupler includes a hinge connecting the control panel to the display, the hinge enabling tilting of the control panel relative to the display. In a still further aspect, the movable coupler includes a telescopic joint connecting the control panel to the display, the telescopic joint enabling extension and retraction of the control panel away from and toward the display, the movable coupler further including a hinge connecting the control panel to the display, the hinge enabling tilting of the control panel relative to the display. In another aspect of this embodiment, the control panel includes a docking station configured to connect a computing device to the control panel. In a variant of this aspect, the docking station includes a charging port configured to coupling to and charging the computing device.

In another embodiment, the present disclosure provides a CNC control, comprising: a display having a curved screen defining a focal point generally directed at a user of the CNC control, the curved screen being surrounded by a bezel having a first pair of edges along a short side of the curved screen and a second pair of edges along a long side of the curved screen; a mounting bracket configured to couple the display to a CNC machine for rotation between a vertical orientation and a horizontal orientation; a control panel coupled to the display and including a plurality of input devices in communication with the display; and a cluster of control boxes configured for removable coupling to the first pair of edges and the second pair of edges, the cluster of control boxes each including a plurality of control boxes having a plurality of auxiliary input devices in communication with the display. In one aspect of this embodiment, the CNC control further comprises at least one control box removably coupled to the control panel, the at least one control box having at least one auxiliary input device. In another aspect, the at least one control box includes a wrist rest for supporting a wrist of a user interacting with the at least one auxiliary input device. In another aspect, the plurality of input devices includes a keyboard. In yet another aspect, the CNC control further comprises a movable coupler connecting the control panel to the display, the movable coupler including one or both of a telescopic joint connecting the control panel to the display to enable extension and retraction of the control panel away from and toward the display and a hinge connecting the control panel to the display and enabling tilting of the control panel relative to the display. In another aspect, the control panel includes a docking station configured to connect a computing device to the control panel. In a variant of this aspect, the docking station includes a charging port configured to coupling to and charging the computing device.

In yet another embodiment, the present disclosure provides a CNC control, comprising: a display having a curved screen configured to couple to a CNC machine to permit rotation and tilting of the curved screen relative to the CNC machine; a control panel coupled to the display and including a plurality of input devices in communication with the display, the control panel being movable relative to the display; and a plurality of control boxes removably coupled to the curved screen, each of the plurality of control boxes including at least one input device in communication with the display. In one aspect of this embodiment, at least one of the plurality of control boxes is removably coupled to the control panel.

In another embodiment, the present disclosure provides a CNC control, comprising: a display having a curved screen configured to couple to a CNC machine to permit rotation of the curved screen relative to the CNC machine; and a control panel dockable to the display and including a plurality of input devices in communication with the display, the control panel being movable relative to the display. One aspect of this embodiment further comprises a plurality of control boxes removably coupled to at least one of the display and the control panel, each of the plurality of control boxes including at least one auxiliary input device in communication with the display.

In another embodiment, the present disclosure provides a CNC control, comprising: a display having a curved screen configured to couple to a CNC machine; and a plurality of control boxes removably coupled to the display, each of the plurality of control boxes including at least one auxiliary input device in communication with the display. One aspect of this embodiment further comprises a control panel dockable to the display and including a plurality of input devices in communication with the display.

In yet another embodiment, the present disclosure provides a CNC control, comprising: a display having a flat panel screen configured to couple to a CNC machine to permit rotation of the flat panel screen relative to the CNC machine; and a control panel dockable to the display and including a plurality of input devices in communication with the display, the control panel being movable relative to the display. One aspect of this embodiment further comprises a plurality of control boxes removably coupled to at least one of the display and the control panel, each of the plurality of control boxes including at least one input device in communication with the at least one of the display and the control panel.

In another embodiment, the present disclosure provides a CNC control, comprising: a display having a flat panel screen configured to couple to a CNC machine; and a plurality of control boxes removably coupled to the display, each of the plurality of control boxes including at least one input device in communication with the display. One aspect of this embodiment further comprises a control panel dockable to the display and including a plurality of input devices in communication with the display.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a perspective view of a conventional industrial CNC control;

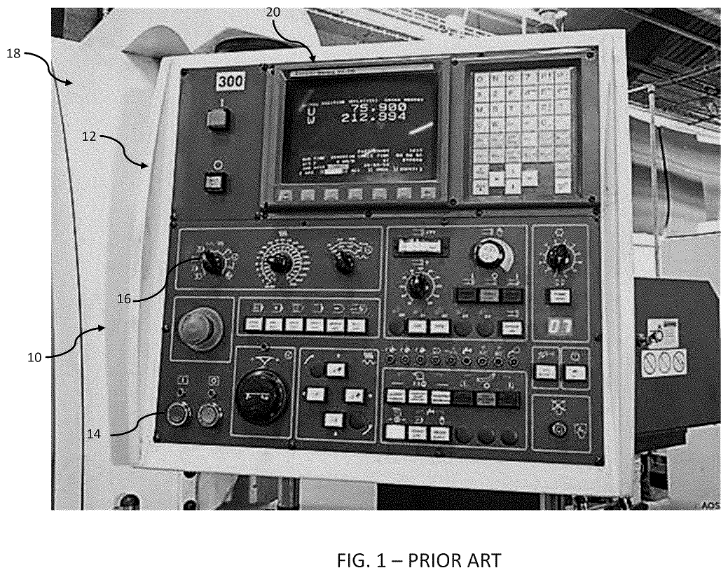

FIG. 2 is a conceptual view of a conventional CNC manufacturing process;

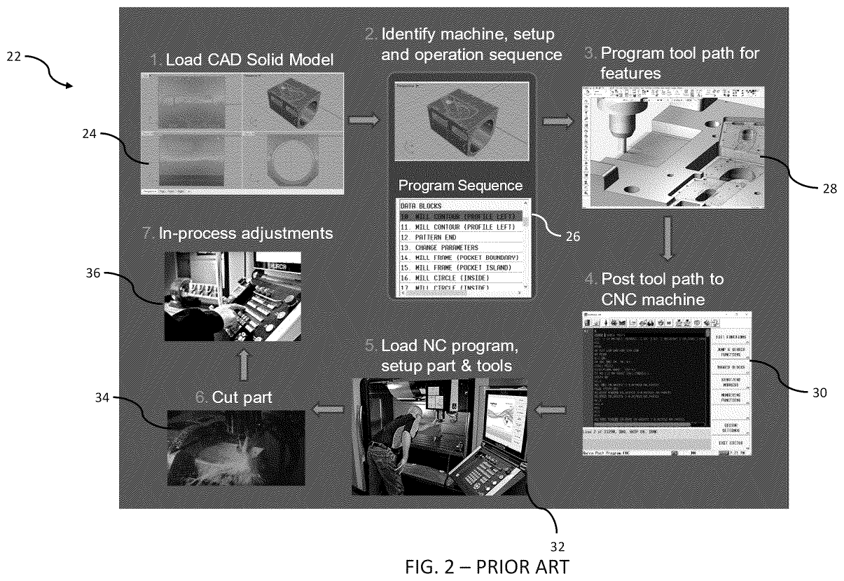

FIG. 3 is a conceptual view of a conventional CNC manufacturing process including on-control part programming;

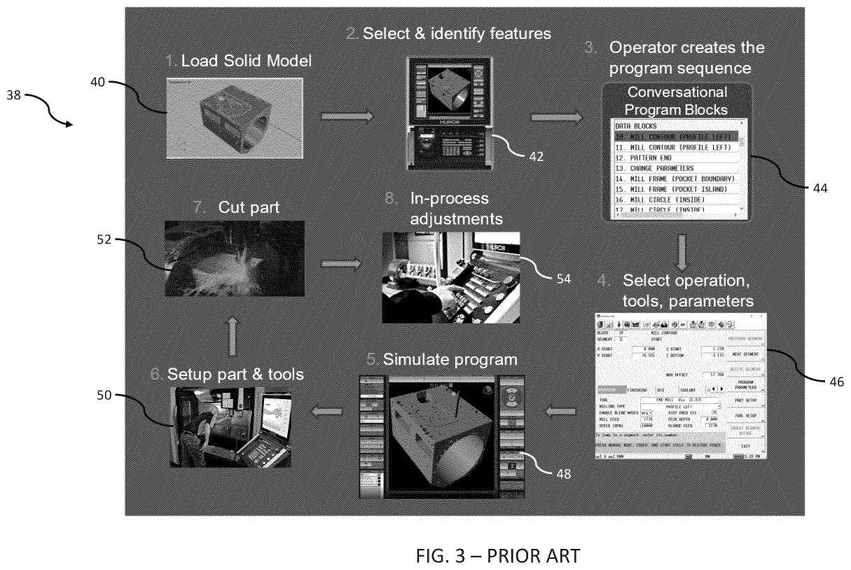

FIG. 4 is a perspective view of conventional a dual CRT screen CNC control;

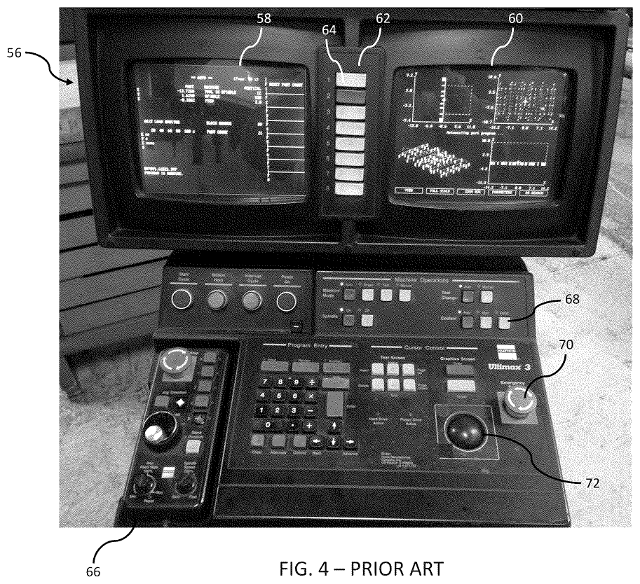

FIGS. 5A-C are perspective views of conventional CNC controls including a single, large flat panel touch-screen;

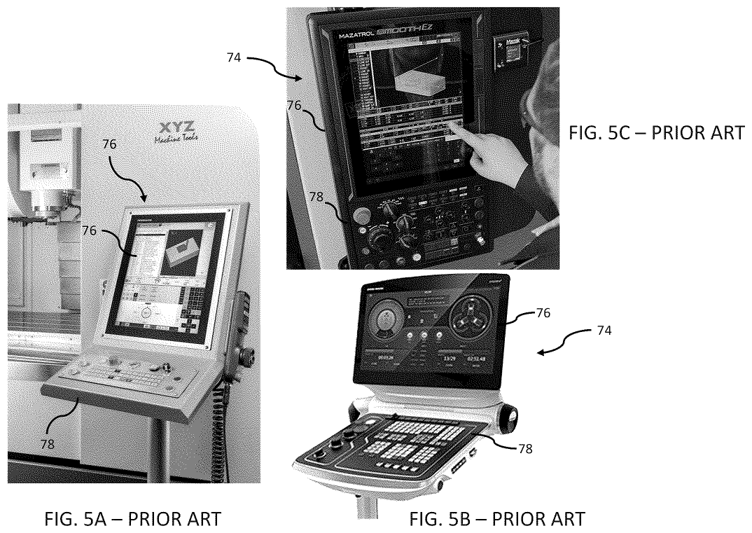

FIGS. 6A-D are perspective views of conventional CNC controls including dual flat panel touch screens;

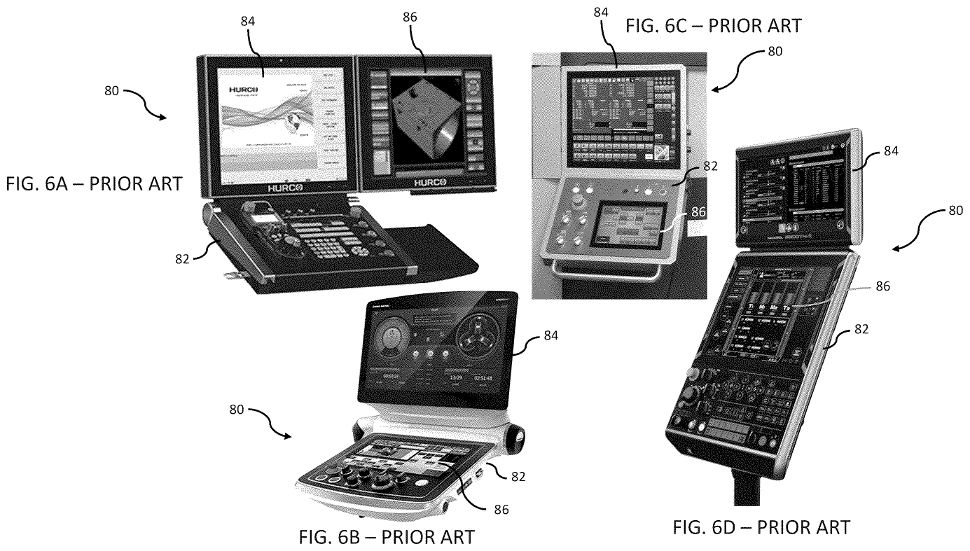

FIGS. 7A and 7B are perspective views of a CNC control according to one embodiment of the present disclosure;

FIG. 8 is a perspective view of a CNC control according to another embodiment of the present disclosure;

FIGS. 9A-C are perspective views of a CNC control according to another embodiment of the present disclosure;

FIG. 10 is a perspective view of a CNC control according to another embodiment of the present disclosure;

FIG. 11 is a perspective view of a wrist rest modular control box according to an embodiment of the present disclosure;

FIG. 12 is a perspective view of a CNC control according to another embodiment of the present disclosure;

FIG. 13 is a perspective view of a CNC control according to another embodiment of the present disclosure;

FIG. 14 is a perspective view of a CNC control according to another embodiment of the present disclosure; and

FIG. 15 is a perspective view of a CNC control according to another embodiment of the present disclosure.

Corresponding reference characters indicate corresponding parts throughout the several views. Although the drawings represent embodiments of the present disclosure, the drawings are not necessarily to scale, and certain features may be exaggerated or omitted in some of the drawings in order to better illustrate and explain the present disclosure.

### DETAILED DESCRIPTION

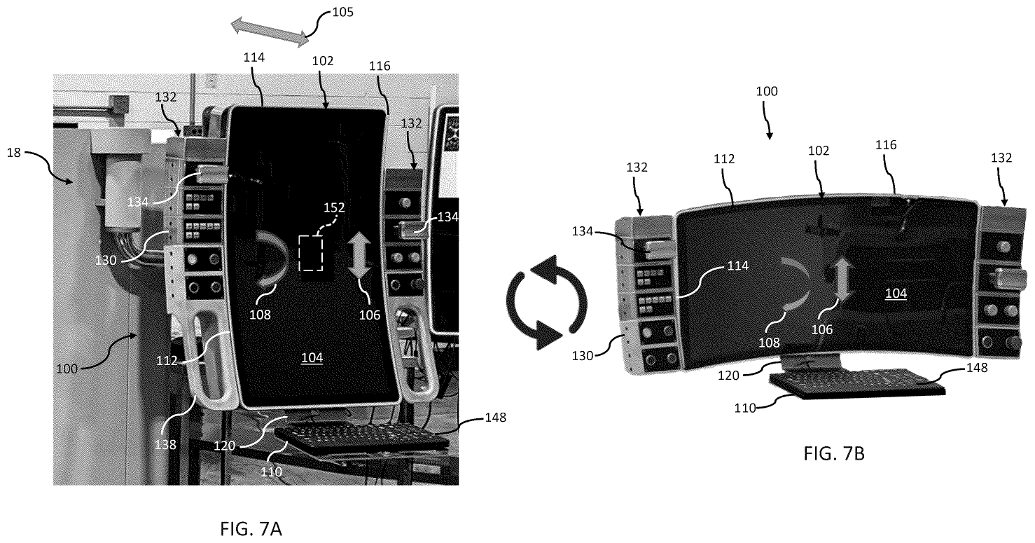

Referring now to FIGS. 7A-B, in one embodiment the present disclosure provides a CNC control 100 that utilizes a large display 102 that eliminates the need for two separate angled flat panel screens. The display 102 includes a curved touch screen 104 that centers the focus of the visual information on the operator who generally stands at a fixed distance in front of the CNC control 100 at the focal point of the curved screen 104. This CNC control 100 is more ergonomic than a single, large flat screen or a dual flat screen design. As described below, the display 102 of the CNC control 100 has vertical adjustments (indicated by arrow 106) and orientation or tilt adjustments (indicated by arrow 108) that allows the display 102 to match any size operator to the focal point of the screen 104. In certain embodiments, the display 102 may also move toward and away from the CNC machine 18 as indicated by arrow 105.

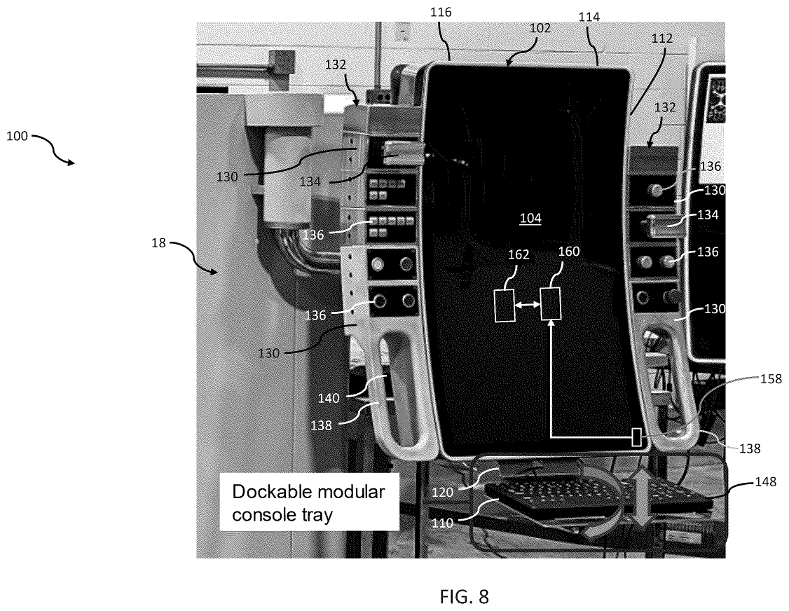

The CNC control 100 according to the present disclosure also includes a rear mounting bracket 152 that enables rotation of the display 102 between a vertical orientation (as shown in FIG. 7A) and a horizontal orientation (as shown in FIG. 7B) based on the operator's preference. Additionally, an orientation sensor 158 (FIG. 8) may be provided on the display 102 to sense the orientation of the display 102. The orientation sensor 158 may be an accelerometer, a gyroscope, a magnetometer, or any other sensor suitable for sensing whether the display 102 is in the vertical orientation or the horizontal orientation. The CNC control 100 also includes at least one processor 160 and at least one memory device 162. The processor 160 executes software stored on the memory device 162 to perform a plurality of functions. Among these many functions related to controlling the CNC machine 18 and enabling user interaction, the processor 160 functions to receive signals from the orientation sensor 158 and process the information for display on the display 102 such that the information corresponds to the current orientation of the display 102. In other words, when the orientation sensor 158 indicates that the display 102 has been reoriented, the processor 160 receives such indication from the sensor 158 and automatically reorients the information on the display 102.

This design presents a unique challenge as CNC controls are typically required to have physical buttons and knobs for various important functions such as Cycle Start, Cycle Stop and Emergency Stop to meet regulatory requirements. In other cases, physical control buttons and knobs are also included by manufacturers to provide easy use of frequently used features or to provide finite precision for operator input. For example, override knobs are expected on CNC controls because digital on-screen sliders do not provide sufficient control. Furthermore, for CNC machines with on-control graphical part programming and simulation capabilities, numeric pads and keyboards are often included for input where physical devices are preferable over touch-screen button input.

As best shown in FIG. 8, to accommodate the physical controls and keyboard, along with the option of a handwheel jog unit in both vertical and horizontal orientations, the CNC control 100 incudes a dockable control panel 110 that can be moved to either the long edge 112 or the short edge 114 of the curved display 102. The dockable control panel 110 can be held in place using magnets (not shown), physical locking levers (not shown), a combination of both mechanisms or other attachment devices. In certain embodiments, the control panel 110 includes a plurality of input devices 154 such as a keyboard 148. The electrical and communication connections between the input devices 154 and the display 102 can be wireless or direct wired with sufficient cable slack for both orientations or dedicated electrical contacts can be made available at both horizontal and vertical dock locations on the bezel 116 of the curved display 102.

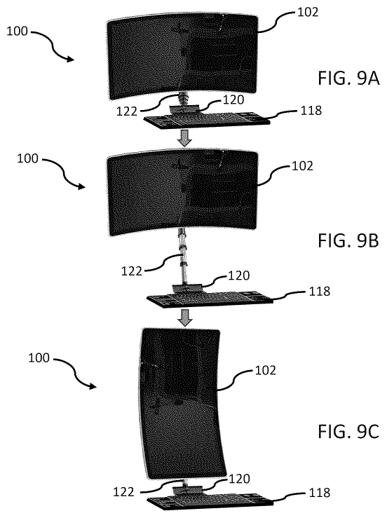

As an alternative to the dockable control panel 110, or in addition to one, the CNC control 100 may include a telescopically mounted control panel 118 as depicted in FIGS. 9A-C. As shown, the telescopic control panel 118 includes a telescoping joint 122 that extends the control panel 118 out of the way when the display 102 is physically being rotated and retracts to the correct operational position to latch to the neighboring side of the display 102. In FIG. 9A, the control panel 118 is shown in its operational position below the display 102 in a horizontal orientation. In FIG. 9B, the telescoping joint 122 is extended, thereby moving the control panel 118 out of the way. In FIG. 9C, the display 102 is shown in after being rotated to a vertical orientation, and the control panel 118 is again in an operational position under the display 102. Either of the dockable control panel 110 or the telescopic control panel 118 may also include a hinge 120 to tilt the control panel 110, 118 relative to the display out of the way during rotation of the display 102 such that the diagonal portions of the display 102 do not interfere with the control panel 110, 118 and the telescopic extension required for rotating the display 102 is reduced. The telescopic joint 122 and the hinge 120 are referred to herein individually and collectively as a movable coupler.

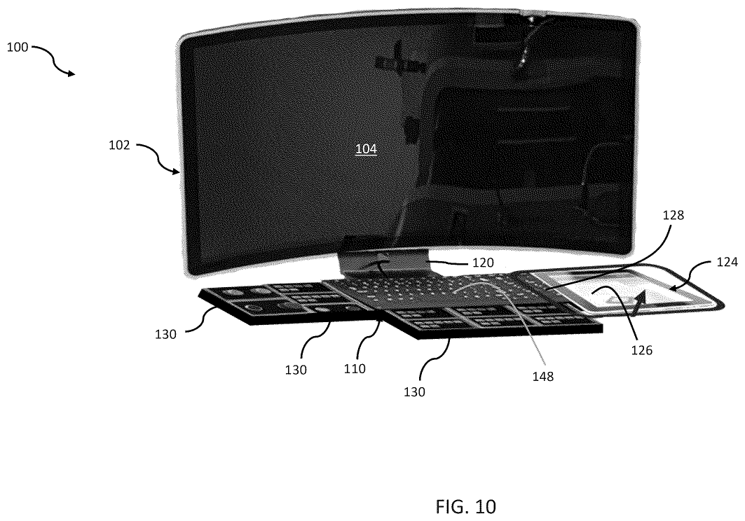

Referring now to FIG. 10, the control panels 110, 118 (control panel 110 is shown in FIG. 10) may also incorporate a docking station 124 for removably connecting input devices 154 such as a tablet computer 126 or other computing device for providing additional input and interaction capabilities for operators to control and program the CNC machine 18. The tablet 126 can be used to interact with the CNC control 100 to program parts, run machine simulations and monitor the CNC machine 18 while the tablet 126 is either docked or removed using wireless communication with the CNC control 100. In certain embodiments, the docking station 124 includes a charging port 128 for charging the tablet 126 or other computing device when it is docked to the docking station 124.

For even further customization, in an alternative embodiment additional input is enabled by configurable control boxes 130 with auxiliary input devices 156 configured to initiate specific functions required of the CNC machine 18. Referring back to FIG. 8, the control boxes 130 can be removed and installed on either side of either the long edge 112 or the short edge 114 of the display 102 to accommodate operator preference and right-hand or left-hand bias. The control boxes 130 may be coupled to the edges 112, 114 of the display 102 using magnets, locking snap connections, tongue and groove connections, or any other suitable connection mechanism that permits removal and relocation of the control boxes 130. The auxiliary input devices 156 of the control boxes 130 may communicate with the display 102 wirelessly or via wired connections.

The individual control boxes 130 may be grouped into control box clusters 132 as shown in FIG. 8. In the example shown, the control box cluster 132 on the left side of the long edge 112 of the display 102 includes one control box 130 with a wrist rest 134 (further described below), two control boxes 130 with auxiliary input devices 156 in the form of a plurality of buttons 136, and an elongated control box 130 with a plurality of buttons 136 and a loop-shaped handle 138 with a central opening 140. The control box cluster 132 on the right side of the long edge 112 of the display 102 includes one control box 130 with a button 136, one control box 130 with a wrist rest 134, and an elongated control box 130 with a plurality of buttons 136 and a loop-shaped handle 138 with a central opening 140. The buttons 136 are electrically connected to the CNC control 100 either wirelessly or through the above-described connection mechanisms along the edges 112, 114 of the display 102 which are configured to mate with contacts on the control boxes 130. In either case, the control boxes 130 are mechanically and removably secured to the display 102. The loop-shaped handles 138 (which may be configured in any of a variety of shapes, with or without central openings 140) are used by the operator to reposition the display 102. These control boxes 130 can be configured based on the machine options and type and can eliminate the dummy buttons often found on controls today that blank out functions and buttons that are not present on the machine.

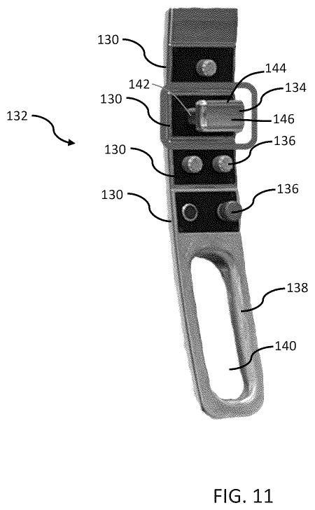

As indicated above, certain modular control boxes 130 are provided with hand/wrist rests 134 for ergonomic use. As best shown in FIG. 11, these wrist rests 134 generally include a post or stem 142 extending from the control box 130 and a body 144 extending from the stem 142. The body 144 may have a curved, concave outer surface 146. Wrist rests 134 are particularly advantageous for control boxes 130 that may require lengthy use by the operator. An example is override controls where an operator may constantly use their fingers to adjust the feedrate when running a program to make sure the program is correct for the first part run.

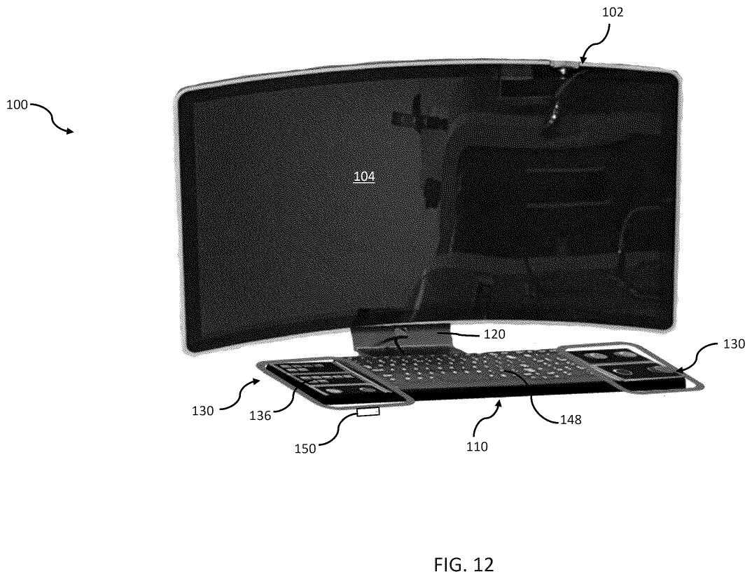

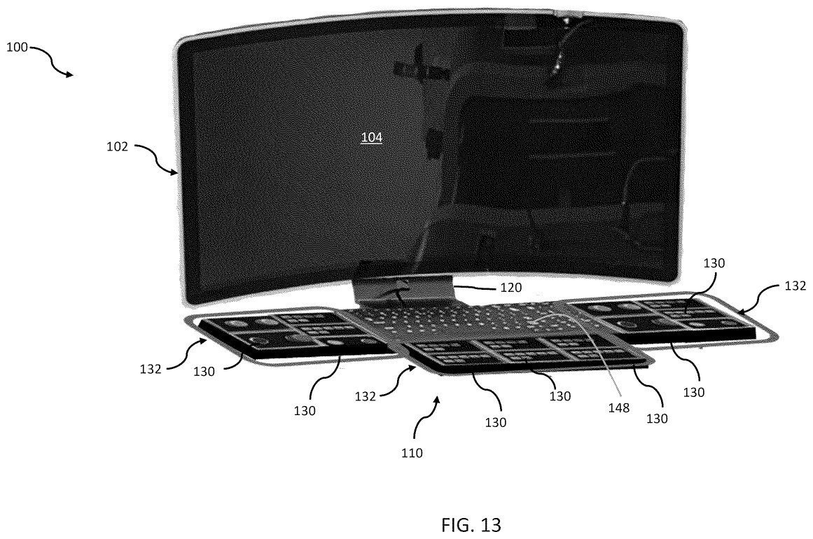

Additionally, while FIG. 8 shows the configurable control boxes 130 mounted to the side of the curved display 102, the concept can be applied to the dockable control panels 110, 118. As shown in FIG. 12, in such an embodiment, the CNC control 100 may include a control panel 110 with a keyboard 148 connected to the display 102 by a hinge 120. The CNC control 100 also includes a pair of control boxes 130 mounted to and electrically connected with the control panel 110, each control box 130 having a plurality of buttons 136. This embodiment permits customization and expansion by stacking modular control boxes 130 to match the functionality available on the specific CNC machine 18. FIG. 13 shows a CNC control 100 with a control panel 110 including a cluster 132 of control boxes 130 on both sides of the keyboard 148 of the control panel 110 and in front of the control panel 110.

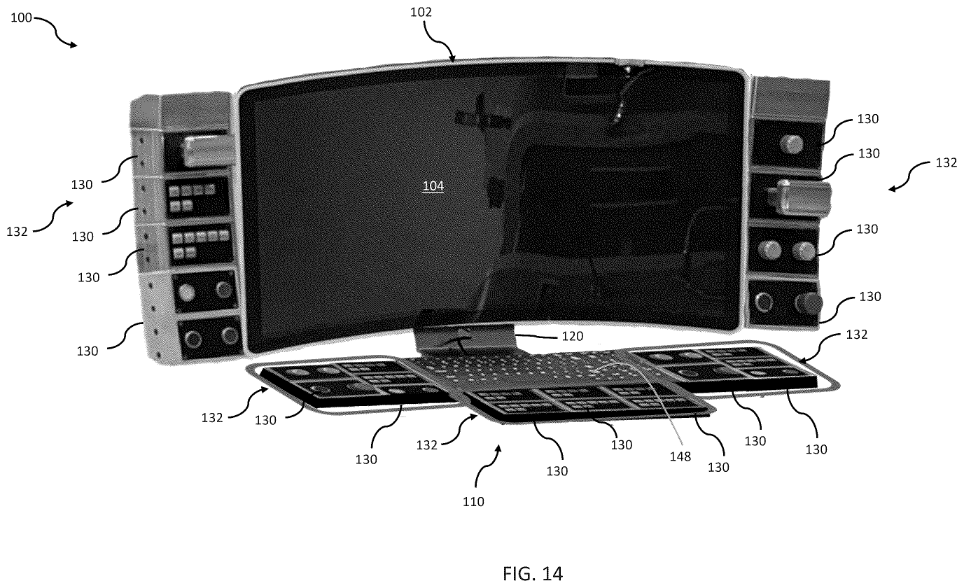

Referring now to FIG. 14, in another embodiment the CNC control 100 includes a dockable control panel 110 and control boxes 130 removably mounted to both the display 102 and the dockable control panel 110. As shown, a control box cluster 132 is docked to both the left and right sides of the display 102, and control box clusters 132 are docked to the left and right sides of the control panel 110 as well as the forward side of the control panel 110. As should be apparent from the foregoing, the control panel 110 may also be a telescopic control panel 118 as shown in FIGS. 9A-C. As should also be apparent, the display 102 may be adjustable as described above and the control box clusters 132 may be docked to the left and right sides of the display 102 when the display 102 is moved to its vertical orientation.

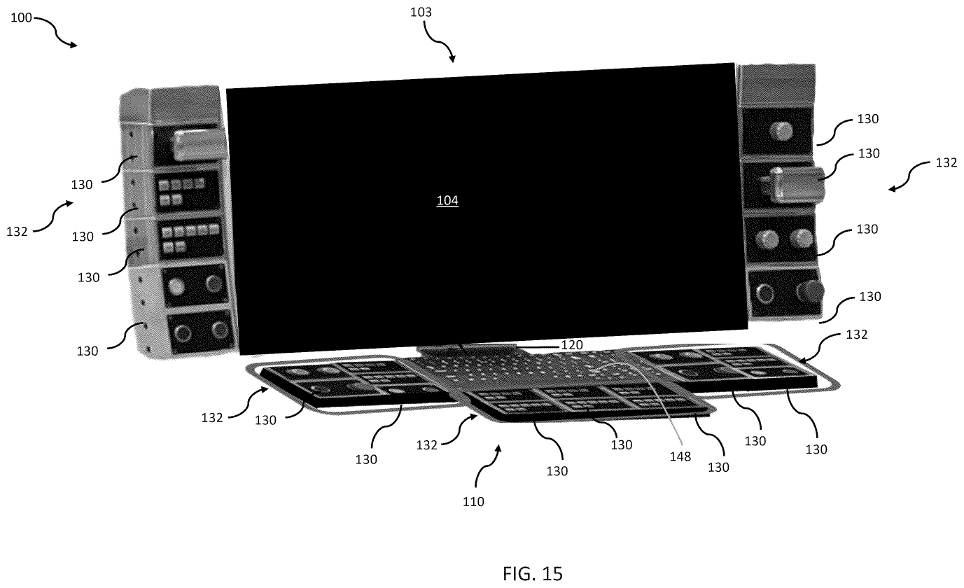

Referring now to FIG. 15, in another embodiment the CNC control 100 includes a dockable control panel 110 and control boxes 130 removably mounted to both a flat panel display 103 and the dockable control panel 110. As shown, a control box cluster 132 is docked to both the left and right sides of the display 103, and control box clusters 132 are docked to the left and right sides of the control panel 110 as well as the forward side of the control panel 110. As should be apparent from the foregoing, the control panel 110 may also be a telescopic control panel 118 as shown in FIGS. 9A-C. As should also be apparent, the display 103 may be adjustable as described above with reference to the curved display 102 and the control box clusters 132 may be docked to the left and right sides of the display 103 when the display 103 is moved to its vertical orientation.

The configurable dockable control panel 110, 118, docking station 124 and configurable control boxes 130 can also support ease of life features. For example, docking charging stations 150 or even wireless charging stations (not shown) for remote jog units or cell phones may be provided. Also, the configurable docking control panel 110, 118 and configurable control boxes 130 may support external third-party software or hardware, for example, machine tending robot controls and automatic doors.

The performance of certain of the operations may be distributed among the one or more processors, not only residing within a single machine, but deployed across a number of machines. In some example embodiments, the one or more processors or processor-implemented modules may be located in a single device or geographic location (e.g., within a home environment, an office environment, or a server farm). In other example embodiments, the one or more processors or processor-implemented modules may be distributed across a number of devices or geographic locations.

In addition, the aspects and functionalities described herein may operate over distributed systems (e.g., cloud-based computing systems and/or network-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Unless specifically stated otherwise, use herein of words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A CNC control, comprising:
a display having a curved screen surrounded by a bezel having a first edge and a second edge, the first edge being longer than the second edge;
a mounting bracket coupled to the display to permit rotation of the display between a vertical orientation and a horizontal orientation;
a control panel including at least one input device in communication with the display; and
a movable coupler connecting the control panel to the display;
wherein the control panel is movable relative to the display via the movable coupler to provide clearance for the display to move between the vertical orientation and the horizontal orientation.

2. The CNC control of claim 1, further comprising:
at least one control box configured for removable coupling to the first edge and/or the second edge of the bezel of the screen, the at least one control box including at least one auxiliary input device in communication with the display.

3. The CNC control of claim 2, wherein the at least one control box is configured for removable coupling to the control panel.

4. The CNC control of claim 2, wherein the at least one control box includes a wrist rest for supporting a wrist of a user interacting with the at least one auxiliary input device.

5. The CNC control of claim 2, wherein the at least one control box includes a first cluster of control boxes removably coupled to one side of the screen and a second cluster of control boxes removably coupled to another side of the screen that is opposite of the one side.

6. The CNC control of claim 1, wherein the at least one input device includes a keyboard.

7. The CNC control of claim 1, wherein the movable coupler includes a telescopic joint connecting the control panel to the display, the telescopic joint enabling extension and retraction of the control panel away from and toward the display.

8. The CNC control of claim 1, wherein the movable coupler includes a hinge connecting the control panel to the display, the hinge enabling tilting of the control panel relative to the display.

9. The CNC control of claim 1, wherein the movable coupler includes a telescopic joint connecting the control panel to the display, the telescopic joint enabling extension and retraction of the control panel away from and toward the display, the movable coupler further including a hinge connecting the control panel to the display, the hinge enabling tilting of the control panel relative to the display.

10. The CNC control of claim 1, wherein the control panel includes a docking station configured to connect a computing device to the control panel.

11. The CNC control of claim 10, wherein the docking station includes a charging port configured to coupling to and charging the computing device.

12. A CNC control, comprising:
a display having a curved screen defining a focal point generally directed at a user of the CNC control, the curved screen being surrounded by a bezel having a first pair of edges along a short side of the curved screen and a second pair of edges along a long side of the curved screen;
a mounting bracket configured to couple the display to a CNC machine for rotation between a vertical orientation and a horizontal orientation;
a control panel coupled to the display and including a plurality of input devices in communication with the display; and
a cluster of control boxes configured for removable coupling to the first pair of edges and the second pair of edges, the cluster of control boxes each including a plurality of control boxes having a plurality of auxiliary input devices in communication with the display.

13. The CNC control of claim 12, further comprising at least one control box removably coupled to the control panel, the at least one control box having at least one auxiliary input device.

14. The CNC control of claim 12, wherein the at least one control box includes a wrist rest for supporting a wrist of a user interacting with the at least one auxiliary input device.

15. The CNC control of claim 12, wherein the plurality of input devices includes a keyboard.

16. The CNC control of claim 12, further comprising a movable coupler connecting the control panel to the display, the movable coupler including one or both of a telescopic joint connecting the control panel to the display to enable extension and retraction of the control panel away from and toward the display and a hinge connecting the control panel to the display and enabling tilting of the control panel relative to the display.

17. The CNC control of claim 12, wherein the control panel includes a docking station configured to connect a computing device to the control panel.

18. The CNC control of claim 17, wherein the docking station includes a charging port configured to coupling to and charging the computing device.

19. A CNC control, comprising:
a display having a curved screen configured to couple to a CNC machine to permit rotation and tilting of the curved screen relative to the CNC machine;
a control panel coupled to the display and including a plurality of input devices in communication with the display, the control panel being movable relative to the display; and
a plurality of control boxes removably coupled to the curved screen, each of the plurality of control boxes including at least one input device in communication with the display.

20. The CNC control of claim 19, wherein at least one of the plurality of control boxes is removably coupled to the control panel.

21. A CNC control, comprising:
a display having a curved screen configured to couple to a CNC machine to permit rotation of the curved screen relative to the CNC machine; and
a control panel dockable to the display and including a plurality of input devices in communication with the display, the control panel being movable relative to the display.

22. The CNC control of claim 21, further comprising a plurality of control boxes removably coupled to at least one of the display and the control panel, each of the plurality of control boxes including at least one auxiliary input device in communication with the display.

23. A CNC control, comprising:
a display having a curved screen configured to couple to a CNC machine; and
a plurality of control boxes removably coupled to the display, each of the plurality of control boxes including at least one auxiliary input device in communication with the display.

24. The CNC control of claim 23, further comprising a control panel dockable to the display and including a plurality of input devices in communication with the display.

25. A CNC control, comprising:
a display having a flat panel screen configured to couple to a CNC machine to permit rotation of the flat panel screen relative to the CNC machine; and
a control panel dockable to the display and including a plurality of input devices in communication with the display, the control panel being movable relative to the display.

26. The CNC control of claim 25, further comprising a plurality of control boxes removably coupled to at least one of the display and the control panel, each of the plurality of control boxes including at least one input device in communication with the at least one of the display and the control panel.

27. A CNC control, comprising:
a display having a flat panel screen configured to couple to a CNC machine; and
a plurality of control boxes removably coupled to the display, each of the plurality of control boxes including at least one input device in communication with the display.

28. The CNC control of claim 27, further comprising a control panel dockable to the display and including a plurality of input devices in communication with the display.
